(19) United States
(12) Patent Application Publication
(10) Pub. No.: US 2025/0200398 A1
(43) Pub. Date: Jun. 19, 2025

(54) UNCERTAINTY DECOMPOSITION FOR IN-CONTEXT LEARNING OF LARGE LANGUAGE MODELS

(71) Applicant: NEC Laboratories America, Inc., Princeton, NJ (US)

(72) Inventors: Xujiang Zhao, Hillsborough, NJ (US); Wei Cheng, Princeton Junction, NJ (US); Haifeng Chen, West Windsor, NJ (US); Yiyou Sun, Plainsboro, NJ (US); Yanchi Liu, Princeton, NJ (US)

(21) Appl. No.: 18/977,415

(22) Filed: Dec. 11, 2024

Related U.S. Application Data
(60) Provisional application No. 63/609,951, filed on Dec. 14, 2023.

(51) Int. Cl. G06N 5/04

(52) U.S. Cl. CPC G06N 5/04

(57) ABSTRACT

Methods and systems for prompting a Large Language Model (LLM) with a set of text data outside pre-inference trained categories and a test prompt for an initial parameter which has a known ground truth, calculating an uncertainty of an LLM's output, selecting another LLM model parameter and calculating the total uncertainty of the LLM's output with the other LLM model parameter. The methods and systems further include prompting the LLM with another test prompt, with the initial LLM parameter and the other LLM parameter, and calculating the total uncertainty of the LLM's output for initial LLM model parameter and the other LLM model parameter, decomposing the total uncertainty of the LLM into Aleatoric Uncertainty (AU) and Epistemic Uncertainty (EU) components, and rating the total uncertainty of the LLM, using the decomposed total uncertainty as a metric.

### RELATED APPLICATION INFORMATION

This application claims priority to U.S. Provisional Patent Application 63/609,951, filed on Dec. 14, 2023, incorporated herein by reference in its entirety.

### BACKGROUND

### Technical Field

The present invention relates to evaluation of results from Large Language Models (LLMs) and more particularly to estimating aleatoric uncertainty and epistemic uncertainty to estimate confidence in LLM outputs.

### Description of the Related Art

Large Language Models (LLMs) have emerged as groundbreaking advancements and revolutionized diverse domains by serving as general task solvers, which can be largely attributed to the emerging capability of in-context learning.

In-context learning is a type of LLM training that happens after the LLM is in the inference phase. One type of in-context learning is few-shot. By providing few-shot examples of a task, LLMs can learn a concept or pattern with limited data and make corresponding responses to the particular task. On many Natural Language Processing (NLP) benchmarks, in-context learning is competitive with supervised learning methods. Uncertainty is still a concern for LLMs, however. Among other issues, LLMs have been known to hallucinate outputs.

Higher uncertainty in LLM output is correlated with less confidence in the results. Similarly, higher probability is related to higher confidence. Presently, there is difficulty determining the source of the uncertainty in an LLM. Uncertainty could be the result of biased data, overfitting, underfitting, inaccurate labeling, inadequate training data, insufficient data, class imbalance, poor training data or other intrinsic limitations of the decoding parameters of the LLM, among other issues.

### SUMMARY

According to an aspect of the present invention, a method is provided for a computer-implemented method for decomposing LLM uncertainty. The method includes prompting a Large Language Model (LLM) with a set of text data outside pre-inference trained categories and a test prompt for an initial parameter which has a known ground truth. The method further includes calculating a total uncertainty of an LLM's output and selecting another LLM model parameter and calculating the total uncertainty of the LLM's output with the other LLM model parameter. The method further includes prompting the LLM with another test prompt, with the initial LLM parameter and the other LLM parameter, and calculating the total uncertainty of the LLM's output for the initial LLM model parameter and the other LLM model parameter, decomposing the total uncertainty of the LLM into a decomposed uncertainty including Aleatoric Uncertainty and Epistemic Uncertainty, and rating the LLM, using the decomposed uncertainty.

According to another aspect of the present invention, a system is provided for decomposing LLM uncertainty. The system includes a hardware processor, and a memory that stores a computer program which, when executed by the hardware processor, causes the hardware processor to prompt a LLM with a set of text data outside pre-inference trained categories and a test prompt for an initial parameter which has a known ground truth. The system further causes the processor to calculate a total uncertainty of an LLM's output, select another LLM model parameter and calculate the total uncertainty of the LLM's output with the other LLM model parameter. The system further causes the hardware processor to prompt the LLM with another test prompt with the initial LLM parameter and one other LLM parameter, and calculate the total uncertainty of the LLM's output for initial LLM model parameter and the other LLM model parameter. The system further causes the processor to decompose the total uncertainty of the LLM into a decomposed uncertainty including Aleatoric Uncertainty (AU) and Epistemic Uncertainty (EU), and rate the LLM, using the decomposed uncertainty.

According to another aspect of the present invention, a computer program product including a non-transitory computer-readable storage medium containing computer program code is provided, the computer program code when executed by one or more processors causes the one or more processors to perform operations. The computer program code includes instructions to prompt an LLM with a set of text data outside pre-inference trained categories and a test prompt for an initial parameter which has a known ground truth. The computer program product further causes the processor to calculate a total uncertainty of an LLM's output, select another LLM model parameter and calculate the total uncertainty of an LLM's output with the other LLM model parameter. The computer program further causes the processor to prompt the LLM with another test prompt, with the initial LLM parameter and other LLM parameter, and calculate the total uncertainty of the LLM's output for initial LLM model parameter and other LLM model parameter. The computer program further causes the processor to decompose the total uncertainty of the LLM into a decomposed uncertainty including Aleatoric Uncertainty (AU) and Epistemic Uncertainty (EU), and rate the LLM, using the decomposed uncertainty.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a system for estimating uncertainties in LLMs, in accordance with an embodiment;

FIG. 2 is a flow diagram of operational steps for computing the uncertainties of a generic LLM in accordance with an embodiment;

FIG. 3 is a flow diagram of operational steps for computing the uncertainties of a white-box LLM in accordance with an embodiment;

FIG. 4 is a flow diagram of operational steps for computing the uncertainties of a white-box LLM in accordance with an embodiment;

FIG. 5 is a flow diagram of operational steps for computing the uncertainties of a black-box LLM in accordance with an embodiment;

FIG. 6 is an example dialogue of few-shot learning demonstrating aleatoric uncertainty;

FIG. 7 is an example of several responses an LLM may output based on varying operational parameters in accordance with an embodiment;

FIG. 8 is a demonstration of a usage cycle of the present invention in accordance with an embodiment;

FIG. 9 is a flow diagram for a method for decomposing LLM uncertainty; and

FIG. 10 is a block diagram of a system for executing instructions for decomposing LLM uncertainties.

### DETAILED DESCRIPTION OF PREFERRED EMBODIMENTS

Noise and potential ambiguity in training data can introduce uncertainty in LLM outputs. This may hinder the credibility and accuracy of outputs produced by the model. In addition, LLM parameters may also raise the uncertainty. Recognizing and quantifying the uncertainty from the model's perspective can be useful in evaluating outputs, which allows users to understand the LLM's reliability based on a query and can make necessary adjustments (e.g., sampling multiple answers and choosing the answer by majority voting) to reduce uncertainty and increase LLMs' confidence. Decomposing uncertainty to subsequently reduce or eliminate LLM uncertainty is provided in accordance with embodiments of the present invention.

Embodiments can leverage Bayesian properties of LLMs to determine their output confidence for a given query. Some embodiments may decompose this uncertainty into separate values directed towards the LLM's training data and operational parameters, respectively. A better understanding of the model can lead to improved training data or identifying a more applicable parameter for a given query.

Existing methodologies tend to empirically quantify the uncertainty of LLM's outputs as a unified value by calculating their variance/entropy of multiple responses or training a surrogate model to directly return a confidence score. In accordance with embodiments of the present invention, a unified value is decomposed using in-context learning and variations in operational parameters. Existing methods can give a measure of uncertainty but cannot determine the underlying causes or the interactions between different factors causing the uncertainty.

To address the need for a better understanding of an LLM's uncertainty, given an LLM's responses to a particular query, a decomposition of uncertainty into primary sources is performed. Specifically, AU, which refers to variations in the data, often linked to the demonstration examples, and EU, which refers to ambiguities related to the model's parameters.

Embodiments of the present invention are applicable in many areas, for example, in the field of medicine. LLMs have the potential to convey medical knowledge, assist in communicating with patients through translations and summaries, and simplifying documentation tasks. Communicating medical knowledge is useful if the LLM is trained on a relevant medical subject. LLMs trained with data relating to dermatology would fail patients with a cardiological issue such as atrial fibrillation. Another issue may be an LLM parameter setting that knows how to translate to and from commonly spoken languages but not to and from less commonly spoken languages. Failure to intimately know the language may cause failures in translations such as oversimplifying inputs or outputs. Simplified documentation tasks may allow LLMs to discard important information that the LLMs parameters do not appreciate the value of. Decomposition of LLM uncertainty to identify and troubleshoot issues can reduce pain points and rework time, among the other benefits LLM uncertainty decomposition brings, including improving computation support.

In accordance with embodiments of the present invention, systems and methods are provided for decomposing the uncertainty of a LLM's output into its component uncertainties.

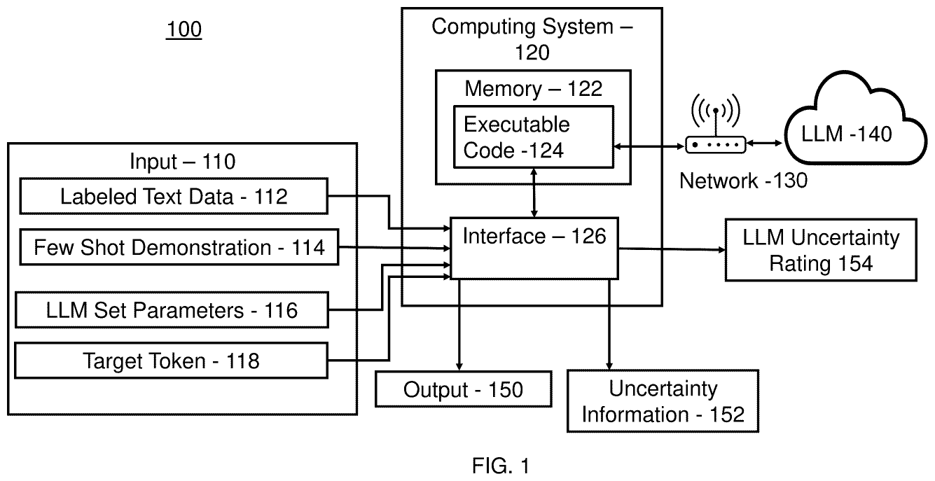

Referring now in detail to the figures in which like numerals represent the same or similar elements and initially to FIG. 1, a system for computing an LLM's 140 uncertainty is shown.

System 100 includes an input 110 which is received by computing system 120. Computing system 120 includes memory 122 and interface 126. Memory 122 can include executable code 124 which can analyze and compute the LLM's 140 uncertainty. Executable code 124 can also communicate with network 130. Network 130 can communicate between executable code 124 and LLM 140.

Input 110 can include labeled text data 112, a few-shot learning demonstration 114, LLM set parameters 116, and one or more target tokens 118. Labeled text data 112 is text data such as sentence questions with known ground truth labels. Few-shot learning demonstration 114 can include a collection of prompts and labels which LLM 140 can learn from in the inference phase of LLM 140. LLM set parameters 116 are various operational parameters of LLM 140 that can be tested to determine a portion of the LLM's 140 decomposed uncertainty. Target token 118 is an input with an associated, a known ground truth, like output 150, which can be used to gather information regarding the LLM's 140 uncertainty, produce uncertainty information 152 and subsequently decompose uncertainty.

Computing system 120 also produces LLM uncertainty rating 154 which evaluates the decomposed total uncertainty and includes an overall rating of the uncertainty. The LLM uncertainty rating 154 can include several embodiments such as a probability, a score, a grade, or another metric. The LLM uncertainty rating 154 can include insights into potential reductions in the total uncertainty and component uncertainties.

LLM uncertainty rating 154 can give indications that LLM 140 is better suited for other purposes and another LLM should be selected for a given task. The LLM uncertainty rating can suggest a low likelihood LLM 140 is the best LLM 140 for generating a proper output 150 for input 110. The suggestion may include a single value, such as a number or color, or provide a comprehensive analysis, separating the determination into discrete components. In some embodiments, the LLM uncertainty rating 154 can offer better alternatives including using a more aptly trained LLM 140 or a better suited LLM parameter 116. The LLM uncertainty rating 154 can also provide recommendations on methods to have an improved experience or methods to tailor the input 110 for a more confident LLM 140 output 150 (a value that indicates the LLM 140 is capable of responding to the input 110 appropriately).

LLM 140 receives input 110, applies NLP on the data contained within the input 110, and generates output 150 in accordance with data LLM 140 has learned from and LLM set parameters 116. The data LLM 140 can train on can include pre-inference training and in-context learning such as few-shot learning demonstration 114. LLM 140 may have specific LLM set parameters 116 which include algorithms dictating the procedure LLM 140 follows when generating output 150, according to some embodiments.

Few-shot learning is one of several in-context learning techniques. Few-shot learning demonstration 114 can include providing LLM 140 with several training examples in the inference phase of LLM 140 with labels that LLM 140 can use for generating outputs 150. LLM 140 can then use this information for properly generating output 150 to new queries. LLM 140 attempts to learn from few-shot learning demonstration 114 and provide outputs 150 that match with the ground truth of target token 118.

In-context learning can be advantageous to pre-inference learning for several reasons. In-context learning can be less computationally intensive than pre-inference learning and may not need persistently stored information (and therefore guarantees stability in model parameters). Few-shot learning demonstration 114 is one of several in-context learning techniques, other in-context learning techniques are contemplated, in accordance with some embodiments of the present invention.

In some instances, uncertainty information 152 may include metadata, in other instances uncertainty information 152 may include discrete values returned to the shareholder along with the output 150. LLM 140 can describe the confidence level of output 150 with uncertainty information 152.

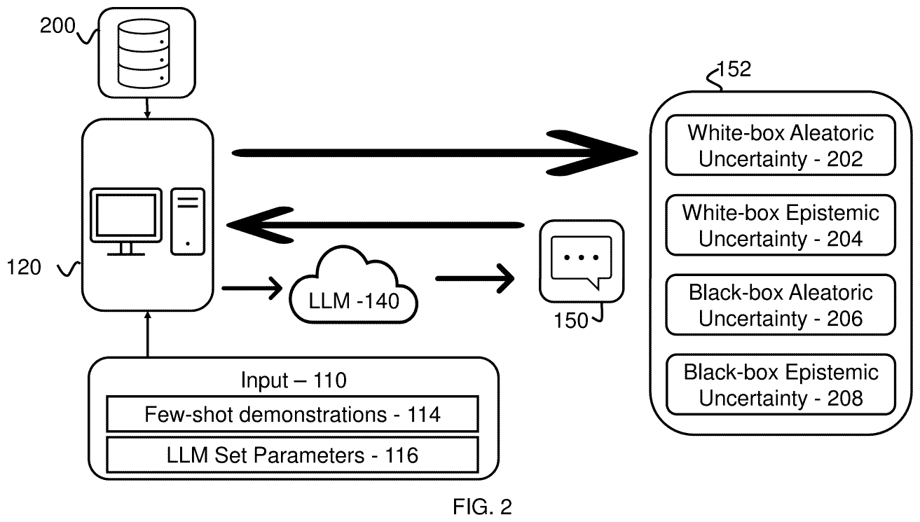

FIG. 2 is a flow diagram of the operational steps of computing a generic LLM's 140 uncertainty. In some embodiments, output 150 can have an accuracy that is proportional to the amount of data LLM 140 has trained on because LLM 140 can draw from more learned material to generate output 150. Therefore, LLM 140 can be trained using, e.g., maximum likelihood estimating on a large corpus of text. One training goal can be to maximize the likelihood of the observed data under LLM 140 and reduce the instances LLM 140 is unfamiliar with input 110. This relationship can be described as: [symbol] (Θ)=Π_{isN}p(ωᵢ|ω₁, ω₂ . . . , ωᵢ₋₁; Θ), where each ωᵢ ∈x is a token in a sequence x=[ω₁, . . . , ω_{N}], and Θ denotes the set of parameters of the LLM. [symbol] (Θ) is the product of the probabilities of ωᵢ occurring conditioned on a LLM set parameter 116, Θ.

LLM set parameters 116 are customizable settings that control how LLM 140 processes input 110 and generates output 150. LLM set parameters 116 are also considered decoding parameters. LLM set parameters 116 can also include hyperparameters as well as parameters. LLM set parameters 116 can include but are not limited to, e.g., greedy search, beam search, top-k sampling, temperature, sampling threshold, and multinominal sampling.

LLM 140 can learn on pre-inference training data or use in-context learning on a set of data in accordance with a latent concept during inference phase of LLM 140. In-context learning can include a small set of inputs 110 and labels which LLM 140 can learn and apply to new situations.

LLM 140 can use in-context learning by mapping the training token sequence x to a latent concept z. The latent concept z is a latent variable sampled from a space of concepts Z, which defines a distribution over observed tokens ωᵢ from a training context x: p(ω₁, . . . , ω_{N})=∫_{z∈Z}p(ω₁, . . . ω_{N}|z)p(z)dz. The probability, p(ω_{N}), is the likelihood of ω_{N} occurring within the set (ω₁ . . . ω_{N}). In some embodiments, the latent concept z can be interpreted as various document-level statistics, such as the general subject matter of the text, the structure/complexity of the text, the overall emotional tone of the text, etc.

Further elaborating on the concept of in-context learning, in some embodiments LLM 140 is given a list of independent and identically distributed (I.I.D.) in-context training examples (including both questions and answers) [x₁, . . . , x_{T_1}], and a concatenated test question (without the task answer) x_{T} as a prompt. Each demonstration xᵢ in the I.I.D. set of examples is drawn as a sequence conditioned on the same latent concept z and describes the task to be learned. LLM 140 will generate a response y_{T} (e.g., output 150) corresponding to the test question x_{T} (e.g., target token 118 (FIG. 1)) based on the provided prompt: p(y_{T}|x_{1:T})=∫_{z∈Z}p(y_{T}|x_{1:T}, z)p(z|x_{1:T})dz. The probability, p(y_{T}|x_{1:T}), is the likelihood of response y_{T} being generated on the condition of input x_{T} from the set x_{1:T}.

The process of in-context learning can be interpreted as locating a pre-existing latent concept z based on the provided demonstrations x_{1:T-1}, which is then employed to apply the information learned on a new task, x_{T}. Including more high-quality examples of few-shot learning demonstration 114 within the prompt which can refine the focus on the relevant concept, enabling LLM 140 selection through the marginalization term p(z|x_{1:T}).

The generation process for outputs 150 can be defined by the function yᵢ=ƒ(xᵢ, z; Θ), where ƒ: [symbol] ×Z→ [symbol] is a deterministic function based on a dataset [symbol] ={ [symbol] , [symbol] } which can consist of token sequences [symbol] ={xᵢ} and corresponding target values [symbol] {yᵢ}. The output 150 (y_{T}) exhibits stochastic behavior, influenced by the latent concept z and the LLM set parameters 116 (e.g., temperature, sampling threshold, etc.).

Input 110 and training data 200 can be received by LLM 140. LLM 140 then can process input 110 in accordance with the data included in input 110, information the LLM 140 has learned from the training data 200, and LLM set parameters 116 to generate output 150 as a response. Depending on the substance of the input 110, the output 150 can vary. Training data 200 can be pre-inference data or in-context learning data like few-shot learning demonstration 114 examples.

According to an embodiment, from a Bayesian view the predictive distribution of LLM 140 for the output 150 (y_{T}) associated with few-shot learning demonstration 114 (x_{1:T-1}) and target token 118 (FIG. 1), x_{T}, is given as:

$$p ( {y}_{T} \vert {x}_{1 : T} ) \approx \int p ( {y}_{T} \vert Θ , {x}_{1 : T} , 𝓏 ) \cdot p ( 𝓏 \vert {x}_{1 : T} ) q ( Θ ) d 𝓏 d Θ \qquad ( 1 )$$

where, p(y_{T}|Θ,x_{1:T}, z) is approximated by a BNN-based likelihood function [symbol] (ƒ(x_{1:T}, z), Σ). [symbol] is a normal distribution and Σ is the covariance matrix which contains the variances and covariances associated with LLM set parameters 116. The probability, p(z), is the likelihood of the latent concept z, and q(Θ) is the approximated posterior of the LLM set parameters 116, denoted as Θ.

Equation (1) results in a single, discrete value and does not separate the probability into AU and EU components.

Input 110 (x_{1:T}) includes target token 118 (FIG. 1), x_{T}, and few-shot learning demonstration 114 (x_{1:T-1}). Input 110 are sampled from training data 200, from token sequences [symbol] . Training data 200 from token sequences [symbol] includes a set of tokens as demonstrated herein. Set x_{1:T} is received by LLM 140 using few-shot learning demonstration 114. By sampling different LLM set parameters 116, where Θᵢ˜q(Θ), the LLM 140 can return different outputs 150 (y_{T}∈[y_{T}¹, . . . , y_{T}^{L}]) based on the conditional probability p(y_{T}|Θ, x_{1:T}, z). This process can be completed several times with different sets of few-shot learning demonstration 114 (x_{1:T-1}), to receive different outputs 150 (y_{T}∈[y_{T}¹, . . . , y_{T}^{L}]). The variations in these outputs 150 are related to the uncertainty of LLM 140. The AU is dependent on the variations in the few-shot learning demonstration 114 (x_{1:T-1}). The EU is dependent on the variations in the LLM set parameters 116, where Θᵢ˜q(Θ). In LLM 140 the confidence score can be decomposed into white-box AU 202 and white-box EU 204 or black-box AU 206 and black-box EU 208.

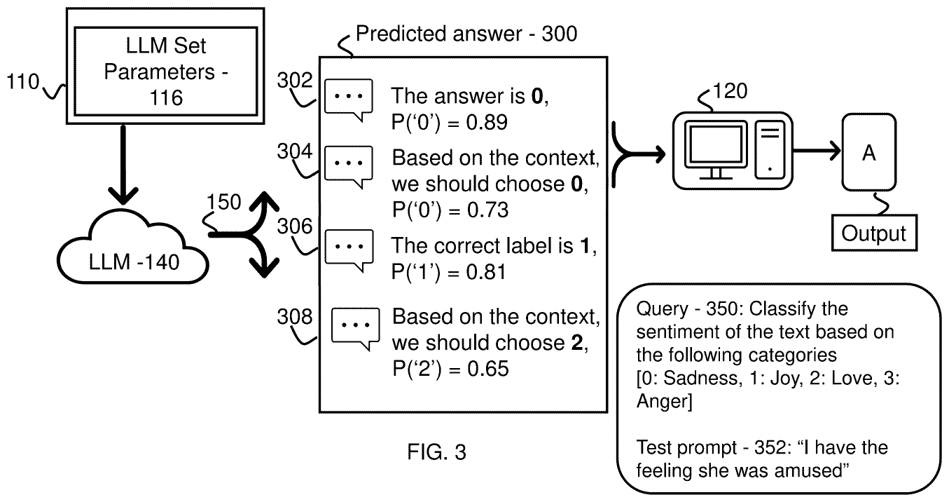

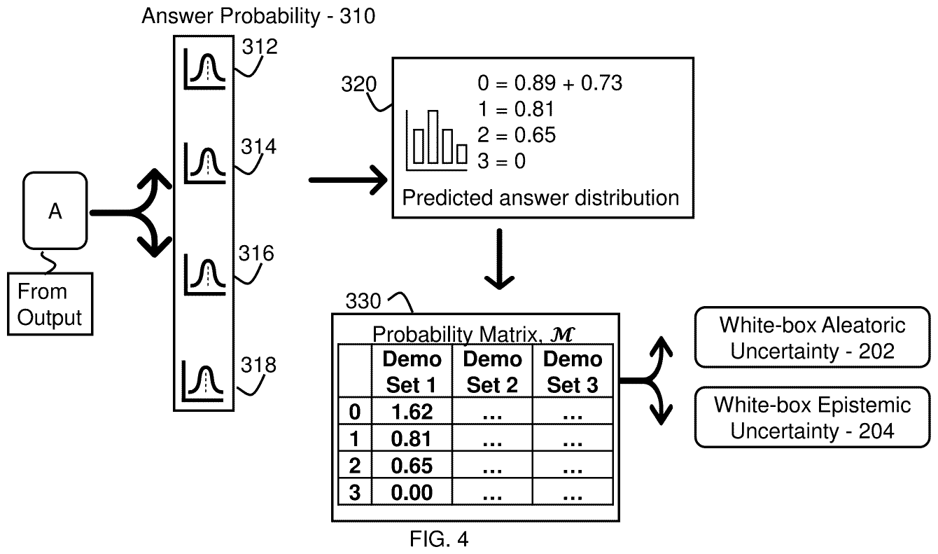

Now referring to FIG. 3 and FIG. 4, training data 200 is learned by LLM 140 via computing system 120 and network 130 (FIG. 1). LLM 140 then generates output 150 according to the training data 200 (FIG. 1) and LLM set parameters 116. Using this information, a predicted answer chart 300 is created. Predicted answer chart 300 contains several responses 302, 304, 306, 308 based on various LLM set parameters 116. The several responses 302, 304, 306, 308 vary and provide information in different forms. Corresponding with each response 302, 304, 306, 308 in the predicted answer chart 300 is an answer probability 312, 314, 316, 318, such that response 302 has answer probability 312, response 304 has answer probability 314, response 306 has answer probability 316, and response 308 has answer probability 318.

The probabilities from answer probabilities 312, 314, 316, 318 are contained in the answer probability chart 310. For each value in the predicted answer chart 300 that is repeated, the corresponding probability in the answer probability chart 310 is summed. A representation of the summed values from the answer probability chart 310 is created as predicted answer distribution 320. After repeating the process L times, where L corresponds to L different sets of few-shot learning demonstration 114, matrix ( [symbol] ) 330 is created. Matrix ( [symbol] ) 330 records output 150 (y_{T}∈[y_{T}¹, . . . , y_{T}^{L}]), of choosing different sets of few-shot learning demonstration 114 and LLM set parameters 116 configurations. The Total Uncertainty (TU) can be approximated as TU=H (σ([ [symbol] _{:,j}])). The EU can be approximated as

$$EU = \frac{1}{L} \sum H ( σ ( {ℳ}_{: , j} ) ) .$$

The AU can be approximated as AU=TU−EU. σ(·) normalizes the column [symbol] _{:j} of matrix ( [symbol] ) 330 into a probability distribution, and H(·) is the differential entropy of a probability distribution. Entropy H(·) can then be calculated as H(·)=−Σₖ₌₁^{K}(p( [symbol] _{k,j}))*log (p( [symbol] _{k,j}))) if the number of labels is K. Entropy is selected to calculate total uncertainty because the two values are approximately equal, and entropy provides a quantifiable and interpretable metric to assess the degree of confidence in the LLM 140 predictions. Since white-box LLMs 140 can return the probability of each token in the generated sequence, entropy-based uncertainty measures are applicable uniformly across different types of white-box LLMs 140.

The entropy H(y_{T}|x_{1:T}, Θ) can also be approximated as H(·)=−Σₜ[p(ωₜ^{y}^{_{T}})−log (ωₜ^{y}^{_{T}})], where p(ωₜ^{y}^{_{T}}) represents the probability of each possible next token ωₜ^{y}^{_{T}} given the input prompt x_{1:T}.

LLMs 140 can leverage the probability distributions of the generated tokens p(y_{T}) for one few-shot learning demonstration 114. Taking the text classification task as an example, LLM 140 can be prompted to directly output a numerical value standing for a predefined category (e.g., 0: Sadness, 1: Joy, etc.). The probability of the token ωₜ^{y}^{_{T}} that represents the numerical value is then leveraged to denote the overall distribution of p(y_{T}). The output 150 (y_{T}∈[y_{T}¹, . . . , y_{T}^{L}]) probabilities are aggregated from all decoded sequences and transformed into an answer distribution.

In predicted answer distribution 320 an example embodiment of the confidence level of several outputs 150 is demonstrated. Response 302 and response 304, have a probability of 0.89 and 0.73 of being label (0), sadness, respectively, and therefore should be summed for a total probability of 1.62 when analyzing the known ground truth associated with target token 118. Response 306 has a probability of 0.81 of being label (1), joy, instead of label (0) or label (2) when analyzing the known ground truth associated with target token 118. Only one LLM set parameter 144 determined label (1), joy, is correct so the probability would not be summed with any other value. Response 308 has a probability of 0.65 of being label (2), love, instead of label (0) or label (1), when analyzing the known ground truth associated with target token 118. Only one LLM set parameter 116 determined label (2), love, is correct so the probability would not be summed with any other value. Label (3) was not output 150 from LLM 140 in any iteration and consequently the confidence level LLM 140 has that the correct label is (3), anger, is 0.00.

In matrix ( [symbol] ) 330 an example embodiment of the probability matrix of several sets of few-shot learning demonstration 114 is demonstrated. The information contained in predicted answer distribution 320 is a single column of matrix ( [symbol] ) 330. Iterating through several sets of few-shot learning demonstration 114, matrix ( [symbol] ) 330 is formed. The variations in outputs 150 in [symbol] each row of a given column can demonstrate EU while the variations in each column can demonstrate AU.

LLM 140 may have a high variance in this particular example because of the limited few-shot learning demonstration 114 or the particular LLM set parameters 116. These could result in unexpectedly high white-box AU 202 and white-box EU 204. Alternatively, the few-shot learning demonstration 114 may not be related to target token 118 (FIG. 1) which would cause a high white-box AU 202. For example, instead of focusing on affiliating emotions with phrases, few-shot learning demonstration 114 could be focused on colors associated with emotions (e.g., green: envy, red: anger, yellow: happy). The inability for LLM 140 to use the information from the in-context learning to apply to target token 118 (FIG. 1) could raise the uncertainty because the LLM is unaware how to react to target token 118 (FIG. 1) since the few-show learning demonstration 114 was unrelated to target token 118. Alternatively, a high white-box EU 204 could arise from a LLM set parameter 116 that focuses on delivering conversational output 150 instead of a more exacting, scientifically accurate output 150.

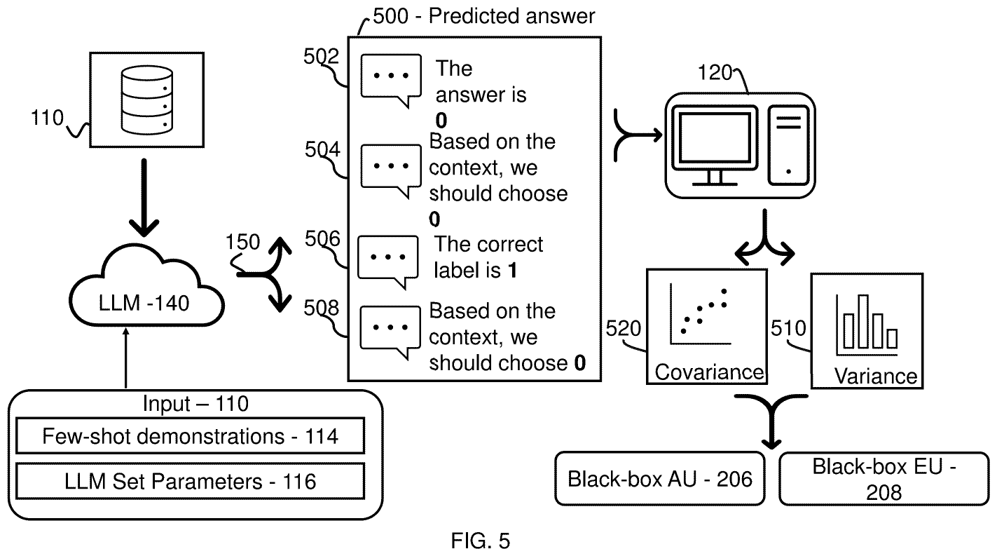

Now referring to FIG. 5, training data 200 (FIG. 2) is fed into LLM. Training data 200 (FIG. 2) can be composed of few-shot learning demonstration 114. LLM 140 can generate output 150 based on this information to produce predicted answers 502, 504, 506, 508. The training data 200 and LLM set parameters 116 parameters can be varied to gather a larger sample size of outputs 150 to apply computations to. Predicted answers 502, 504, 506, 508 are contained within predicted answer chart 500.

Metadata can then be computed by computing system 120 from collected answer chart 500. The metadata can include variance 510 and covariance 520 of the answers in predicted answer chart 500. The variance 510 and covariance 520 provide information about the black-box AU 206 and black-box EU 208 such that the total uncertainty of LLM 140 can be decomposed, as described herein. Variance 510 and covariance 520 are two of many statistical methods used, however other statistical calculations are contemplated to achieve the same or similar results according to some embodiments of the present invention.

The variance 510 of output 150 in predicted answer chart 500 can be used to compute uncertainty for black-box LLMs. Assuming σ²(·) computes the variance of a probability distribution, the total uncertainty present in Equation (1) is then σ²(y_{T}|x_{1:T}). Based on the law of total variance:

$${σ}^{2} ( {y}_{T} \vert {x}_{1 : T} ) = {σ}_{q ( Θ )}^{2} ( Θ ) ( 𝔼 [ {y}_{T} \vert {x}_{1 : T} , Θ ] ) + {𝔼}_{q ( Θ )} [ {σ}^{2} ( {y}_{T} \vert {x}_{1 : T} , Θ ) ] \qquad ( 4 )$$

where [symbol] [y_{T}|x_{1:T}, Θ] and σ²(y_{T}|x_{1:T}, Θ) are mean and variance 510 of y_{T} given p(y_{T}|x_{1:T}, Θ), respectively. The σ_{q(Θ)}²(Θ)( [symbol] [y_{T}|x_{1:T}, Θ]) is the variance 510 of [symbol] [y_{T}|x_{1:T}, Θ] of LLM set [symbol] parameter 116 Θ˜q(Θ). This value represents the black-box EU 208 because the value does not depend on latent concept z. In contrast, [symbol] _{q(Θ)}[σ²(y_{T}|x_{1:T}, Θ)] represents the black-box AU 206 since the value denotes the average value of σ²(y_{T}|x_{1:T}, Θ) with Θ˜p(Θ) and does not depend on LLM set parameter 116 Θ.

Black-box LLMs (e.g., ChatGPT) have multiple hyperparameters (e.g., temperature and top_p) allowing the LLMs to return different responses. Specifically, outputs 150, which include [y_{T}¹, . . . , y_{T}^{R}], can be obtained through querying the LLM 140 with different sets of few-shot learning demonstration 114, which include [x_{1:T-1}¹, . . . , y_{T-1}^{R}], R times. Different LLM set parameter 116 configurations are denoted as [Θ₁, . . . , Θ_{M}]. The expected output 150 ( [symbol] [y_{T}|x_{1:T}, Θ]) can then be calculated for input 110 and LLM set parameter 116, Θ. Calculating the variance 510 with respect to a set of LLM set parameter 116 configurations over all sets of few-shot learning demonstration 114 determines the EU. The variance 510 of the uncertainty, σ²(y_{T}), can also be obtained given a set of few-shot learning demonstration 114 over all LLM set parameters 116. Averaging the variance 510 over the certain LLM set parameter 116 can be used to obtain the AU.

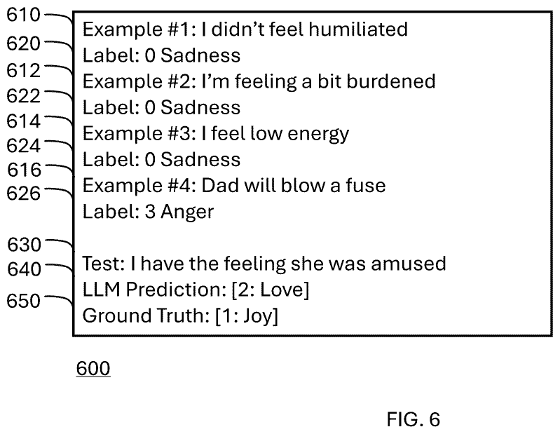

Now referring to FIG. 6, interface 600 is an example graphical user interface that is within computing system 120 (FIG. 1). The interface 600 includes few-shot learning demonstration 114 and target token 118 (FIG. 1). FIG. 6 is demonstrating AU and can be used to decompose LLM 140 (FIG. 1) uncertainty. The example demonstrations 610, 612, 614, 616 and corresponding example labels 620, 622, 624, 626 are entered into interface 600 along with test prompt 630. The example demonstrations 610, 612, 614, 616 can include sentences, phrases, sequences, or patterns expressing an idea such as an emotion. The example labels 620, 622, 624, 626 can include an accurate description of the emotion or other descriptors conveyed in the example demonstrations 610, 612, 614, 616 to which the shareholder is wanting the LLM 140 (FIG. 1) to learn. The interface 600 then can display a LLM prediction 640 (e.g., output 150 (FIG. 1)). LLM prediction 640 has a known ground truth 650 that the LLM prediction 640 can be compared to. This process tests the AU uncertainty of LLM 140 (FIG. 1) has on new inputs 110 (FIG. 1) that have not already been learned.

If example demonstrations 610, 612, 614, 616 and corresponding example labels 620, 622, 624, 626 are only related to negative emotions LLM prediction 640 will likely fail to comprehend a positive emotion such as test prompt 630. There were not sufficient example demonstrations 610, 612, 614, 616 and corresponding example labels 620, 622, 624, 626 to understand the proper emotion and will not be able to accurately predict an appropriate response such as LLM prediction 640. This is an example of a high AU because the inadequacy in example demonstrations 610, 612, 614, 616 and corresponding example labels 620, 622, 624, 626. Had example demonstrations 610, 612, 614, 616 and corresponding example labels 620, 622, 624, 626 been more relevant to test prompt 640 and there is a higher likelihood LLM prediction would have included ground truth 650.

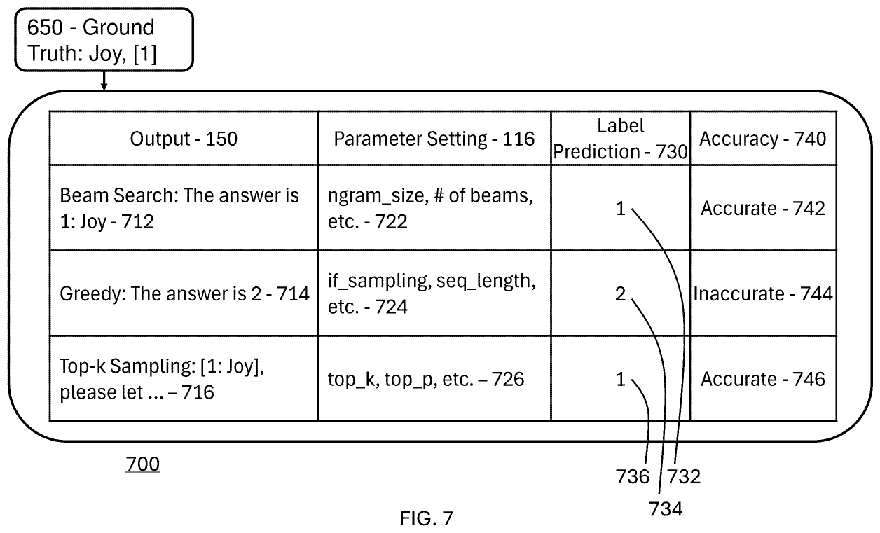

Now referring to FIG. 7, LLM parameter board 700 exemplifies EU. LLM set parameters 116 have uncertainty intrinsic in their algorithms. Assuming identical data, various LLM set parameters can vary in their respective output 150. In some instances, the data contained in output 150 may remain in the same, but in some instances it may not.

LLM parameter board 700 has columns for output 150, LLM set parameters 116, the LLM label prediction 730, and the accuracy of the LLM label prediction 740. The example outputs 712, 714, 716 vary based on the associated example LLM set parameter 722, 724, 726. Within each example output 712, 714, 716 is an example LLM label prediction 732, 734, 736 that has an absolute accuracy 742, 744, 746 that is correct or not when compared to ground truth 650. Different example LLM set parameters 722, 724, 726 can result in different LLM label predictions 732. 734. 736. In FIG. 7 it can be assumed that the information provided to each example LLM set parameter 722, 724, 726 is identical.

In an example embodiment of the present invention output 150 contains three different example outputs 712, 714, 716. Example output 712 uses Beam search and example output 716 uses top-k sampling, both have example label prediction 732, 736 of (1). This is accurate, 742, 746 when compared to ground truth 650. Example LLM set parameter 724 resulted in example label prediction 734 of (2). This is inaccurate 744 when compared to ground truth 650.

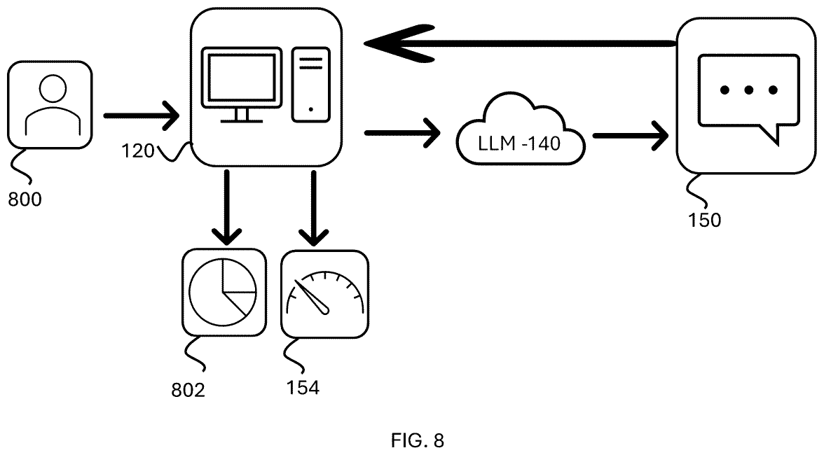

Now referring to FIG. 8, an application of an embodiment of the present invention is provided. Determining the AU and EU can elucidate the need for changes necessary to reduce the uncertainty most effectively and efficiently. The present invention can also be collected over several queries on different topics and can be cumulative. This is especially useful for black-box LLMs where uncertainty is not directly outputted with the output 150. Modification to the approaches of entering queries can occur as a result of uncertainty information 802. This can include changing the query language or format (e.g., syntax, diction, or tone) in some embodiments. In other embodiments, the LLM set parameters 116 (FIG. 1) can be altered or other LLMs 140 with more suitable parameters can be selected.

User 800 interacts with LLM 140 via computing system 120. The LLM 140 can draw from training data 200 (FIG. 2) and input 110 (FIG. 1) to generate the output 150. Training data 200 (FIG. 2) can include few-shot learning demonstration 114 or pre-inference data. In some embodiments training data 200 (FIG. 2) can be a combination of few-shot learning demonstration 114 and pre-inference data. LLM 140 can provide output 150 and analytical information 802. Analytical information 802 can include total uncertainty, white-box AU 202 (FIG. 2), white-box EU 204 (FIG. 2), black-box AU 206 (FIG. 2), black-box EU 208 (FIG. 2), and advanced analytics to recommend methods or actions to improve uncertainty and output 150 quality. Analytical information 802 can also encompass uncertainty information 152 (FIG. 1), including variance 510 (FIG. 5) and covariance 520 (FIG. 5). Based on output 150 and analytical information 802, user 800 can enter a new query that is better suited to their goals.

LLM uncertainty rating 154 can correspond with analytical information 802 to allow user 800 to evaluate a best course of action. The LLM uncertainty rating 154 and analytical information 802 can inform user 800 of potential theoretical or third party imposed limits on LLM 140 or areas of weakness and strength of training data 200 (FIG. 2). Though depicted separately in FIG. 8, in some embodiments, analytical information 802 can include LLM uncertainty rating 154.

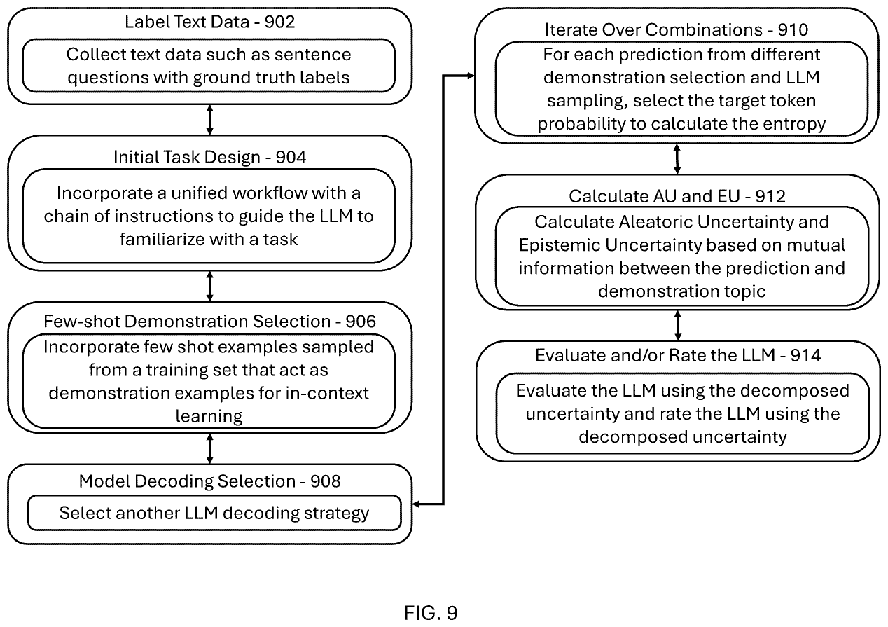

Now referring to FIG. 9, a flow chart of the process of calculating the uncertainty of LLM 140 (FIG. 1) is shown as described. In block 902, text data is labeled. In embodiments this may be labelling the text data with sentence questions with their respective ground truths. In block 904, the initial prompt design is set. This includes incorporating a unified workflow with a chain of instructions to guide the model step-by-step to become familiar with a task. In block 906, few-shot learning demonstration 114 (FIG. 1) is selected. This includes few-shot learning demonstration 114 (FIG. 1) examples sampled from the training data 200 (FIG. 2) that act as examples for in-context learning. In block 908, a model decoding setting is selected (e.g., LLM set parameters 116 (FIG. 1)). This includes selecting different LLM modeling decoding strategies for model sampling. In block 910, a target token 118 (FIG. 1) is selected for calculating the entropy for each demonstration selection and model sampling. In block 912, the AU and EU are decomposed based on mutual information between the prediction and demonstration topic from the total entropy of LLM 140 (FIG. 1). In block 914, the LLM is evaluated and/or rated based on a decomposed uncertainty including the AU and EU.

The decomposed uncertainty can relate to a confidence score affiliated with an output 150 (FIG. 1) with a known ground label for a white-box LLM. The decomposed uncertainty can relate to an output 150 (FIG. 1) and variance 510 (FIG. 5) when compared to expected answers in outputs 150 (FIG. 5) for a black-box LLM.

The decomposed uncertainty can help users 800 (FIG. 8) make informed decisions about the LLM 140 (FIG. 1). For example, a botanist attempting to study coniferous trees can sample several questions to the LLM (e.g., few-shot learning demonstration 114 (FIG. 1)) such as the appropriate climate for coniferous trees. Embodiments of the present invention can then generate a decomposed uncertainty along with output 150 (FIG. 1) which can indicate whether the LLM 140 (FIG. 1) is familiar with coniferous trees and the typical climates coniferous trees thrive in. Additionally, user 800 (FIG. 8) can identify the level of technical preciseness that the LLM 140 (FIG. 1) will likely generate a response with. The LLM 140 (FIG. 1) may use varying levels of terms to describe data such as using the term “pinecone” or “strobilus” to describe the protective coating of a coniferous tree's seed.

These insights, among the other benefits, are technical improvements to computing systems and can streamline evaluating and/or rating of LLMs 140 (FIG. 1). Furthermore, they can allow the user 800 (FIG. 8) to better comprehend the abilities, strengths, limitations, and weaknesses of LLM 140 (FIG. 1). Based on the decomposed uncertainty's evaluation and/or rating user 800 (FIG. 8) can choose from a variety of options including electing to modify the approach taken when using LLM 140 (FIG. 1), maintaining the approach, electing to use another LLM 140 (FIG. 1).

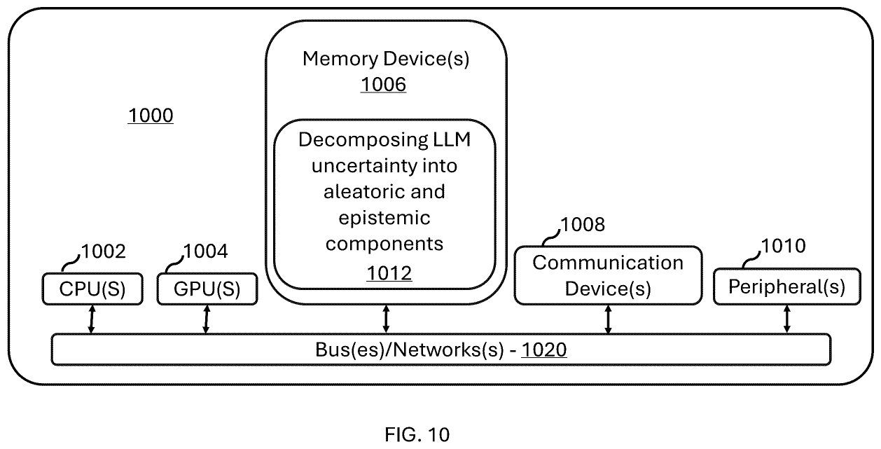

Now referring to FIG. 10 which is an exemplary architecture of a system 1000, in accordance with an embodiment of the present invention. The system 1000 includes a set of processing units (e.g., CPUs) 1002, a set of GPUs 1004, a set of memory devices 1006, a set of communication devices 1008, and a set of peripherals 1010. The CPUs 1002 can be single or multi-core CPUs. The GPUs 1004 can be single or multi-core GPUs. The one or more memory devices 1006 can include caches, RAMs, ROMs, and other memories (flash, optical, magnetic, etc.). The communication devices 1008 can include wireless and/or wired communication devices (e.g., network (e.g., WIFI, etc.) adapters, etc.). The peripherals 1010 can include a display device, a user input device, a printer, an imaging device, and so forth. Elements of system 1000 are connected by one or more buses or networks (collectively denoted by the figure reference numeral 1020).

In an embodiment, memory devices 1006 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 1006 store program code for implementing one or more of the following: a set of instructions to decompose LLM uncertainty into its aleatoric and epistemic components 1012.

Of course, the system 1000 may also include other elements (not shown), as readily contemplated by one of skill in the art, as well as omit certain elements. For example, various other input devices and/or output devices can be included in system 1000, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the system 1000 are readily contemplated by one of ordinary skill in the art given the teachings of the present invention provided herein.

Moreover, it is to be appreciated that various figures as described herein with respect to various elements and steps relating to the present invention that may be implemented, in whole or in part, by one or more of the elements of system 1000.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
prompting a Large Language Model (LLM) with a set of text data outside pre-inference trained categories and a test prompt for an initial parameter which has a known ground truth;
calculating a total uncertainty of an LLM's output;
selecting at least one other LLM model parameter and calculating the total uncertainty of the LLM's output with the at least one other LLM model parameter;
prompting the LLM with at least one other test prompt, with the initial LLM parameter and the at least one other LLM parameter, and calculating the total uncertainty of the LLM's output for initial LLM model parameter and the at least one other LLM model parameter;
decomposing the total uncertainty of the LLM into a decomposed uncertainty including Aleatoric Uncertainty (AU) and Epistemic Uncertainty (EU); and
rating the LLM, using the decomposed uncertainty.

2. The computer-implemented method of claim 1, wherein, decomposing the total uncertainty includes employing the AU for white-box LLMs by relating an LLM's confidence score to an LLM's accuracy.

3. The computer-implemented method of claim 1, wherein, decomposing the total uncertainty includes employing the EU for white-box LLMs by relating an LLM's confidence score to an LLM's accuracy over several iterations of varying LLM model parameters.

4. The computer-implemented method of claim 1, wherein, decomposing the total uncertainty includes employing the AU for black-box LLMs by comparing an expected value of LLM output with an actual output.

5. The computer-implemented method of claim 1, wherein, decomposing the total uncertainty includes employing the EU for black-box LLMs by comparing an expected value of LLM output with an actual output over several iterations of varying LLM model parameters.

6. The computer-implemented method of claim 1, wherein, prompting the LLM with a set of text data includes in-context learning.

7. The computer-implemented method of claim 6, wherein, prompting the LLM with set of text data further includes prompting using few-shot learning.

8. A system, comprising:
a hardware processor; and
a memory that stores a computer program which, when executed by the hardware processor, causes the hardware processor to:
prompt a Large Language Model (LLM) with a set of text data outside pre-inference trained categories and a test prompt for an initial parameter which has a known ground truth;
calculate a total uncertainty of an LLM's output;
select at least one other LLM model parameter and calculating the total uncertainty of the LLM's output with the at least one other LLM model parameter;
prompt the LLM with at least one other test prompt, with the initial LLM parameter and the at least one other LLM parameter, and calculating the total uncertainty of the LLM's output for initial LLM model parameter and the at least one other LLM model parameter;
decompose the total uncertainty of the LLM into a decomposed uncertainty including Aleatoric Uncertainty (AU) and Epistemic Uncertainty (EU); and
rate the LLM, using the decomposed uncertainty.

9. The system of claim 8, further comprising;
decomposing the AU for white-box LLMs includes relating an LLM's confidence score to an LLM's accuracy.

10. The system of claim 8, further comprising;
decomposing the EU for white-box LLMs includes relating an LLM's confidence score to an LLM's accuracy over several iterations of varying LLM model parameters.

11. The system of claim 8, further comprising;
decomposing the AU for black-box LLMs includes comparing an expected value of LLM output with an actual output.

12. The system of claim 8, further comprising;
decomposing the EU for black-box LLMs includes comparing an expected value of LLM output with an actual output over several iterations of varying LLM model parameters.

13. The system of claim 8, wherein the at least one test prompt includes in-context learning.

14. The system of claim 13, wherein the in-context learning includes few-shot learning demonstration.

15. A computer program product comprising a non-transitory computer-readable storage medium containing computer program code, the computer program code when executed by one or more processors causes the one or more processors to perform operations, the computer program code comprising instructions to:
prompt a Large Language Model (LLM) with a set of text data outside pre-inference trained categories and a test prompt for an initial parameter which has a known ground truth;
calculate a total uncertainty of an LLM's output;
select at least one other LLM model parameter and calculating the total uncertainty of an LLM's output with the at least one other LLM model parameter;
prompt the LLM with at least one other test prompt, with the initial LLM parameter and the at least one other LLM parameter, and calculating the total uncertainty of the LLM's output for initial LLM model parameter and the at least one other LLM model parameter;
decompose the total uncertainty of the LLM into a decomposed uncertainty including Aleatoric Uncertainty (AU) and Epistemic Uncertainty (EU); and
rate the LLM, using the decomposed uncertainty.

16. The computer program product of claim 15, further comprising;
decomposing the AU for white-box LLMs includes relating an LLM's confidence score to an LLM's accuracy.

17. The computer program product of claim 15, further comprising;
decomposing the EU for white-box LLMs includes relating an LLM's confidence score to an LLM's accuracy over several iterations of varying LLM model parameters.

18. The computer program product of claim 15, further comprising;
decomposing the AU for black-box LLMs includes comparing an expected value of LLM output with an actual output.

19. The computer program product of claim 15, further comprising;
decomposing the EU for black-box LLMs includes comparing an expected value of LLM output with an actual output over several iterations of varying LLM model parameters.

20. The computer program product of claim 15, wherein the one or more test prompt includes in-context learning.
